(19) United States
(12) Patent Application Publication
(10) Pub. No.: US 2026/0163290 A1
(43) Pub. Date: Jun. 11, 2026

(54) HOUSING COVER AND CHARGING INLET

(71) Applicant: YAZAKI CORPORATION, Tokyo (JP)

(72) Inventors: Masanori Nakamura, Kakegawa-shi (JP); Takao Murakami, Kakegawa-shi (JP); Shinichi Kamura, Kakegawa-shi (JP)

(21) Appl. No.: 19/412,855

(22) Filed: Dec. 9, 2025

(30) Foreign Application Priority Data
Dec. 11, 2024 (JP) 2024-216272

(51) Int. Cl. H01R 13/447; B60L 53/16

(52) U.S. Cl. CPC H01R 13/447; B60L 53/16

(57) ABSTRACT

A housing cover is attached to an opening that opens toward one side in a first direction in a housing of a charging inlet. The housing cover includes: a pair of facing sides facing each other in a second direction intersecting the first direction; and a connecting side connecting ends on one side in a third direction intersecting the first direction and the second direction of the pair of facing sides. The connecting side is more likely to be bent than each of the pair of facing sides, and in a state of being elastically deformed by displacement of bringing ends on another side in the third direction of the pair of facing sides close to each other, the housing cover is fitted into and attached to the opening of the housing.

### BACKGROUND OF THE INVENTION

### Field of the Invention

Embodiments of the present invention relate to a housing cover and a charging inlet.

Priority is claimed on Japanese Patent Application No. 2024-216272 filed in Japan on Dec. 11, 2024, the content of which is incorporated herein by reference.

### Description of Related Art

In the related art, a connector installed in a vehicle has been proposed in order to supply (charge) electric power from the outside of the vehicle to a battery mounted on the vehicle such as an electric vehicle or a plug-in hybrid vehicle (see, for example, Patent Document 1). This type of connector is also generally referred to as a charging inlet.

### PRIOR ART DOCUMENT

### Patent Document

Patent Document 1: Japanese Unexamined Patent Application, First Publication No. 2019-186022

### SUMMARY OF THE INVENTION

A power feeding connector (mating component) is attached to and detached from the charging inlet from one side in the first direction. A region avoiding the terminal holding portion in the housing of the charging inlet is an opening that opens toward one side in the first direction. It is conceivable to attach a housing cover so as to close the opening.

One embodiment is to provide a housing cover and a charging inlet capable of improving assemblability of the housing cover to the housing.

A housing cover according to one embodiment is a housing cover that is attached to an opening that opens toward one side in a first direction in a housing of a charging inlet, the housing cover including: a pair of facing sides facing each other in a second direction intersecting the first direction; and a connecting side connecting ends on one side in a third direction intersecting the first direction and the second direction of the pair of facing sides, wherein the connecting side is more likely to be bent than each of the pair of facing sides, and in a state of being elastically deformed by displacement of bringing ends on another side in the third direction of the pair of facing sides close to each other, the housing cover is fitted into and attached to the opening of the housing.

According to one embodiment, it is possible to provide a housing cover and a charging inlet capable of improving assemblability of the housing cover to the housing.

### BRIEF DESCRIPTION OF THE DRAWINGS

FIG. 1 is a perspective view of a charging inlet and a housing cover according to an embodiment.

FIG. 2 is a perspective view of the housing cover according to the embodiment as viewed from a direction different from that in FIG. 1.

FIG. 3A is a front view of the housing cover according to the embodiment before elastic deformation.

FIG. 3B is a front view of a state in which the housing cover of the embodiment is elastically deformed.

FIG. 3C is an enlarged view of a portion C in FIG. 3B.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted. The constitution which will be described below does not limit the scope of the embodiments.

In the present disclosure, the terms are defined as follows. The term “connection” is not limited to a mechanical connection, and may include an electrical connection. That is, the “connection” is not limited to a direct connection between two elements to be connected to each other, and may include a connection between two elements to be connected to each other with another element interposed therebetween. The term “accommodation” is not limited to a case where the entire component is accommodated, and may include a case where only a part of the component is accommodated (a state in which the remaining part of the component protrudes). The term “facing” indicates that virtual projection images of two target objects overlap each other when viewed from a specific direction. That is, the term “facing” is not limited to a case where two target objects directly face each other, and may include a case where two target objects face each other in a state in which another member exists between the two target objects. “Parallel”, “orthogonal”, or “the same” may include “substantially parallel”, “substantially orthogonal”, or “substantially the same”, respectively.

Note that in the present disclosure, a description will be given on the assumption that the arrow X direction in the drawings indicates a front-rear direction, the arrow Y direction indicates a left-right direction, and the arrow Z direction indicates an up-down direction. In the embodiments, a fitting direction (insertion/removal direction) of the charging inlet 1 and the power feeding connector (not illustrated) will be described as the front-rear direction. In the present disclosure, in the front-rear direction, a side of the power feeding connector is referred to as a front side, and a side of the charging inlet 1 is referred to as a rear side. The power feeding connector is fitted and connected to the charging inlet 1 through movement from the front side to the rear side and is removed through movement in the opposite direction. Left and right sides in the left-right direction are left and right sides when facing forward. In the embodiments, a first connector portion 3 and a second connector portion 4 described later are arranged side by side in the up-down direction. The first connector portion 3 is located above the second connector portion 4.

Hereinafter, in a case where the X direction and the Y direction are not distinguished, the directions may be referred to as “horizontal direction”. Hereinafter, the present embodiment will be described with an example in which the X direction is the “front-rear direction”, the Y direction is the “left-right direction”, and the Z direction is the “up-down direction”. Hereinafter, the +X direction is referred to as “front”, the −X direction is referred to as “rear”, the +Y direction is referred to as “left”, the −Y direction is referred to as “right”, the +Z direction is referred to as “upper”, and the −Z direction is referred to as “lower”. However, these expressions do not limit the gravity direction of the charging inlet 1 (installation posture of the charging inlet 1).

### First Embodiment

### 1. Constitution of Charging Inlet

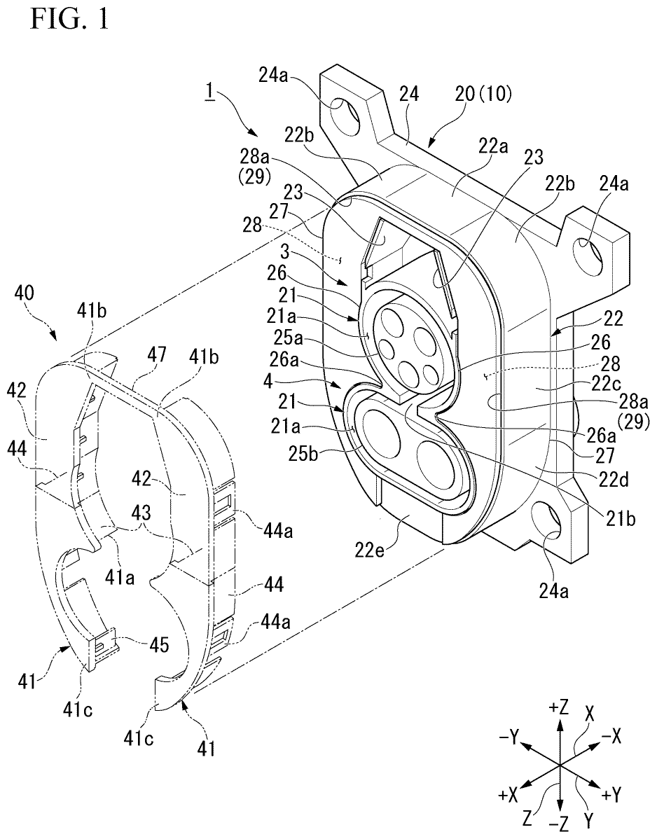

FIG. 1 is a perspective view of the charging inlet 1 in the first embodiment. The charging inlet 1 is an in-vehicle component. The charging inlet 1 is a connector to be assembled to a vehicle body of a vehicle equipped with a battery, such as an electric vehicle (EV) or a plug-in hybrid electric vehicle (PHEV). A power feeding connector (not illustrated) on a power feeding device (not illustrated) side is fitted to the charging inlet 1 when the battery of the vehicle is charged. In a state where the power feeding connector is fitted to the charging inlet 1, power is fed from the power feeding device to the vehicle side to charge the battery.

The charging inlet 1 according to the present embodiment includes the first connector portion 3 and the second connector portion 4. A plurality of signal terminals and power terminals are attached to the first connector portion 3 and the second connector portion 4 from the −X direction. For example, a plurality of signal terminals connected to a signal line and a plurality of power terminals connected to a power line are inserted into and mounted on the first connector portion 3. For example, a pair of power terminals connected to the power line is inserted and mounted on the second connector portion 4. The charging inlet 1 includes a housing 10 and a housing cover 40.

### 2. Constitution of Housing

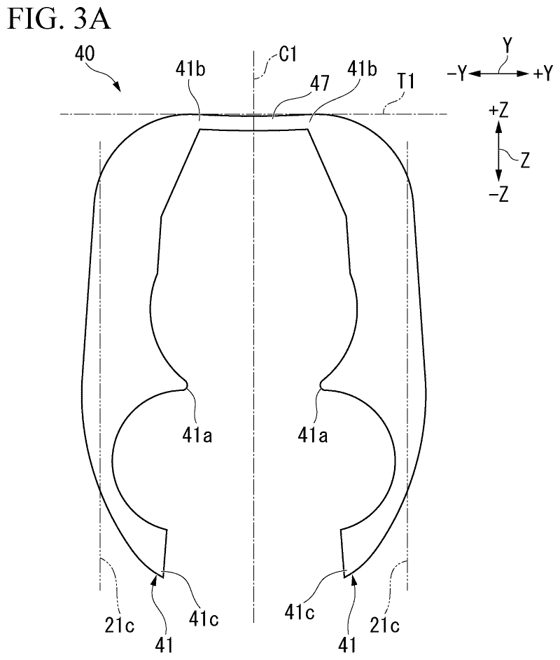

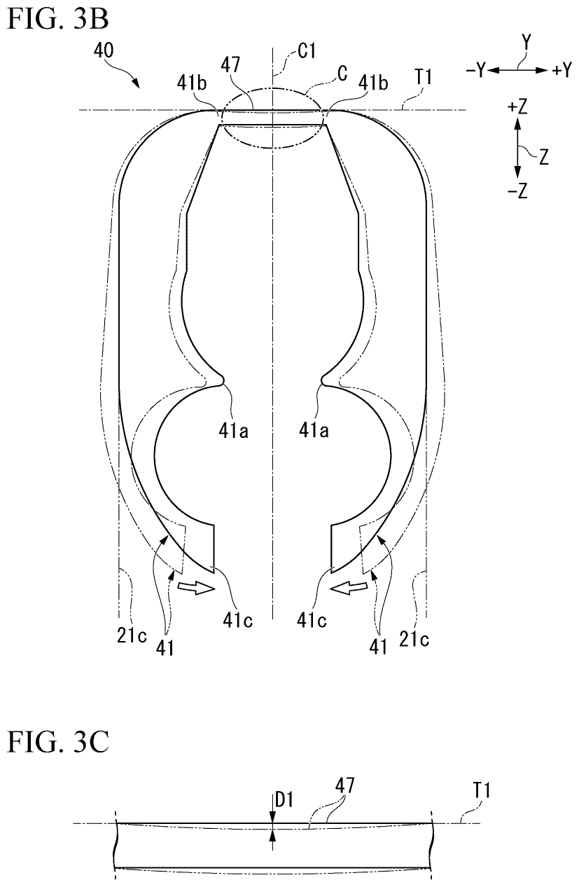

The housing 10 includes a front housing 20 and a rear housing (not illustrated) continuous from the rear of the front housing 20. The front housing 20 is molded from synthetic resin. The front housing 20 includes an inner peripheral wall portion 21, an AC socket 25a, a DC socket 25b, an outer peripheral wall portion 22, and a mounting flange 24. The front housing 20 is provided symmetrically with respect to a center plane C1 (see FIG. 3A) which is located at the center of the entire left and right width and orthogonal to the Y direction.

The inner peripheral wall portion 21 is formed in a cylindrical shape extending in the X direction. An internal space 21a that opens toward the +X direction is formed in a region surrounded by the inner peripheral wall portion 21. The internal space 21a is defined by the inner peripheral surface of the inner peripheral wall portion 21. The power feeding connector (not illustrated) inserted from the +X direction is fitted into the internal space 21a. In the present embodiment, two inner peripheral wall portions 21 are provided side by side in the up-down direction (Z direction).

The AC socket 25a that is cylindrical and extends in the X direction is arranged in a site surrounded by the inner peripheral wall portion 21 on the upper side (+Z direction side). A signal terminal and a power terminal (not illustrated) are inserted into and held by the AC socket 25a from the-X direction. Only one AC socket 25a is arranged in the upper inner peripheral wall portion 21. The upper inner peripheral wall portion 21 is formed in a cylindrical shape along the outer peripheral surface of the AC socket 25a. The upper inner peripheral wall portion 21, the AC socket 25a, the signal terminal, and the power terminal constitute the first connector portion 3.

The pair of DC sockets 25b that are cylindrical and extend in the X direction is arranged in a site surrounded by the inner peripheral wall portion 21 on the lower side (Z direction side). A power terminal is inserted into and held by each DC socket 25b from the −X direction. Each power terminal is a charging terminal through which a charging current flows. The pair of DC sockets 25b is arranged side by side in the Y direction. The inner peripheral wall portion 21 that is elliptical and is long in the Y direction as viewed from the X direction is formed so as to surround the arrangement site of the pair of DC sockets 25b from the outer peripheral side. By inserting the power feeding connector into the lower inner peripheral wall portion 21, the power feeding connector is connected to the pair of power terminals. The lower inner peripheral wall portion 21, the DC socket 25b, and the pair of power terminals constitute the second connector portion 4.

The upper inner peripheral wall portion 21 and the lower inner peripheral wall portion 21 are connected to each other in the Z direction. A lower end of the upper inner peripheral wall portion 21 and an upper end of the lower inner peripheral wall portion 21 are cut out so as to form a gap 21b in the Y direction. Since the lower end of the upper inner peripheral wall portion 21 and the upper end of the lower inner peripheral wall portion 21 are connected to each other in the Z direction, the internal space 21a of the upper inner peripheral wall portion 21 and the internal space 21a of the lower inner peripheral wall portion 21 communicate with each other through the gap 21b.

The outer peripheral wall portion 22 is provided so as to surround the arrangement sites of the both upper and lower inner peripheral wall portions 21 from the outer peripheral side. The outer peripheral wall portion 22 is formed in a cylindrical shape extending in the X direction. The outer peripheral wall portion 22 forms an outer shape of a site of the front housing 20 excluding the mounting flange 24. The outer peripheral wall portion 22 has a rectangular shape that is long in the up-down direction and chamfered at four corners in an arc shape when viewed from the X direction. An end in the +X direction of the front housing 20 (including the ends in the +X direction of the outer peripheral wall portion 22 and the upper and lower inner peripheral wall portions 21) is formed along a plane orthogonal to the X direction.

The outer peripheral wall portion 22 includes an upper surface portion 22a extending in the Y direction, a pair of left and right upper arc portions 22b respectively continuous with left and right sides of the upper surface portion 22a, a pair of left and right side surface portions 22c continuous below the left and right upper arc portions 22b, a pair of left and right lower arc portions 22d continuous below the left and right side surface portions 22c, and a lower surface portion 22e extending between left and right inner ends of the left and right lower arc portions 22d. The lower arc portion 22d is formed in an arc shape having a curvature smaller than that of the upper arc portion 22b and is arranged so as to be located on the inner side in the left-right direction toward the lower side of the lower arc portion 22d. The left and right side surface portions 22c are parallel to each other and extend in the up-down direction.

Between the upper surface portion 22a and the upper inner peripheral wall portion 21, a pair of left and right upper vertical wall portions 23 is formed such that the pair of left and right upper vertical wall portions 23 once extend in the +Z direction and then bend and extend to the left and right insides from the left and right sides of the inner peripheral wall portion 21 toward the left and right sides of the upper surface portion 22a. Above the inner peripheral wall portion 21, a trapezoidal space surrounded on three sides by the upper surface portion 22a and the left and right upper vertical wall portions 23 when viewed from the X direction is formed.

Hereinafter, a wall portion in which the upper vertical wall portion 23, the side of the upper inner peripheral wall portion 21, and the side of the lower inner peripheral wall portion 21 are continuously formed on both left and right sides of the front housing 20 is referred to as a wavy wall portion 26. A recess 26a recessed toward a space between the upper and lower inner peripheral wall portions 21 is formed in the intermediate portion in the up-down direction of the left and right wavy wall portions 26.

Further, a wall portion where the upper arc portion 22b, the side surface portion 22c, and the lower arc portion 22d are continuously formed on both left and right sides of the front housing 20 is referred to as an outer wall portion 27. A side space 28 that is long in the up-down direction is formed between the outer wall portion 27 and the wavy wall portion 26. A site surrounded by the ends of the outer wall portion 27 and the wavy wall portion 26 in the +X direction is a side opening 28a that opens the side space 28 toward the +X direction. An opening 29 that opens in the +X direction in the front housing 20 is formed including the left and right side openings 28a.

The mounting flange 24 projects further toward the outer peripheral side from the outer peripheral wall portion 22 when viewed from the X direction. The mounting flange 24 has bolt holes 24a on the left and right sides of the upper portion and the left and right sides of the lower portion of the outer peripheral wall portion 22 when viewed from the X direction. Mounting bolts (not illustrated) are inserted into the bolt holes 24a, and the mounting bolts are screwed and tightened into screw holes (not illustrated) on the vehicle body side, whereby the charging inlet 1 is attached to the vehicle body. A rear housing (not illustrated) protrudes behind the mounting flange 24, and guides a power line or the like to the inside of the vehicle body.

### 3. Constitution of Housing Cover

As illustrated in FIG. 1, the housing cover 40 is attached to the opening 29 that opens toward the +X direction in the front housing 20 of the charging inlet 1.

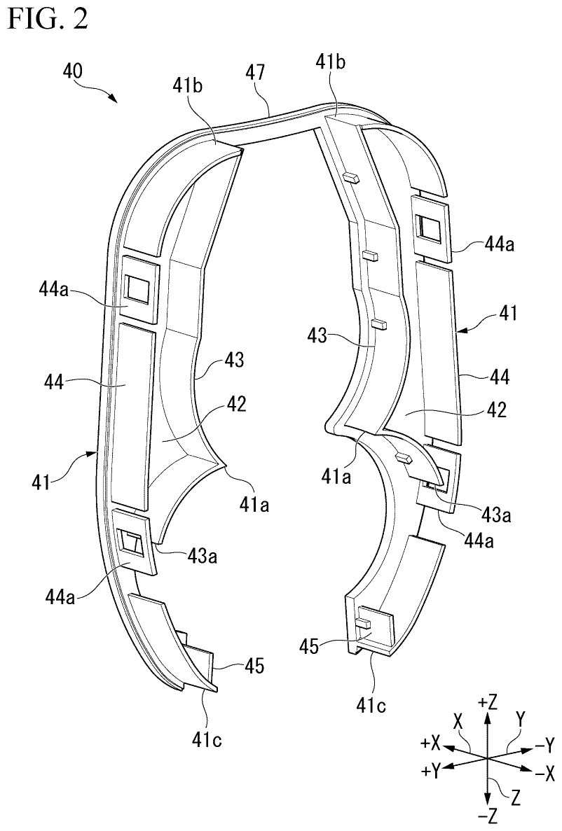

Referring also to FIGS. 2 and 3A, the housing cover 40 includes a pair of facing sides 41 facing each other in the Y direction, and a connecting side 47 connecting upper ends 41b of the pair of facing sides 41 in the Z direction. The housing cover 40 is an integrally molded product made of an insulating resin. The housing cover 40 is provided symmetrically with respect to the center plane C1. Reference number 41c in the drawings denotes the lower end of each of the facing sides 41.

Each of the facing sides 41 includes a cover plate portion 42 having a shape overlapping the side space 28 and the opening 28a when viewed from the X direction. The cover plate portion 42 has a flat plate shape along a plane orthogonal to the X direction. An inside-wall portion 43 extends along the X direction from the side edge on the inside in the left-right direction (the side close to the center plane C1) of the cover plate portion 42. An outside-wall portion 44 extends along the X direction from the side edge on the outside in the left-right direction (the side far from the center plane C1) of the cover plate portion 42. Each of the facing sides 41 has a U-shaped cross-sectional shape that opens rearward by the cover plate portion 42 forming the front wall and the inside-wall portion 43 and the outside-wall portion 44 forming the left-right direction inner wall. Each of the facing sides 41 has the U (in other words, bowl-like) cross-sectional shape described above and extends in the Z direction. A lower end wall portion 45 facing the rectangular parallelepiped lower surface portion 22e from the outside in the left-right direction is formed behind the lower end portion of the cover plate portion 42. Each of the facing sides 41 is not limited to a bowl-like shape in which a part of the cross-sectional shape is opened, and may be a hollow shape in which the cross-sectional shape is closed.

The inside-wall portion 43 is formed along the outer surface in the left-right direction of the wavy wall portion 26 of the front housing 20. The outside-wall portion 44 is formed along the inner surface in the left-right direction of the outer wall portion 27 of the front housing 20. Elastic pieces 44a to be locked to locking claws (not illustrated) formed on the inner surface of the outer wall portion 27 when the housing cover 40 is attached to the front housing 20 are formed at a plurality of upper and lower positions of the outside-wall portion 44. In the lower portion of the inside-wall portion 43, since the left and right widths of the facing sides 41 are narrowed on the left and right outer sides of the lower inner peripheral wall portion 21, a notch 43a is formed to avoid interference with the outside-wall portion 44 by cutting out the inner peripheral wall portion 21. A protrusion 41a to be inserted into the recess 26a formed in the intermediate portion in the up-down direction of the wavy wall portion 26 of the front housing 20 is formed in the intermediate portion in the up-down direction of the inside-wall portion 43.

The connecting side 47 has a cross-sectional shape narrower than the cross-sectional shape of each of the facing sides 41 in the Z direction (the above-described U-shaped cross-sectional shape) and extends in the Y direction. The connecting side 47 is more likely to be bent than the facing sides 41 (particularly likely to be bent along a plane orthogonal to the X direction), and is likely to be elastically deformed as described later when the housing cover 40 is attached to the front housing 20. The connecting side 47 has a solid cross-sectional shape with respect to each of the facing sides 41 of the hollow cross section. The connecting side 47 is formed so as to be flush with the cover plate portion 42 (so as to form a part of the cover plate portion 42). The phrase “more likely to be bent than the facing sides 41” described above means that, for example, the moment of inertia of area is smaller than in the facing sides 41. In a case where the facing sides 41 and the connecting side 47 are formed of different materials, the elastic coefficients of the respective materials may be made different.

FIG. 3A is a front view of a single unit state in which no external force acts on the housing cover 40 as viewed from the X direction.

As illustrated in FIG. 3A, in the housing cover 40, the lower sides of the left and right facing sides 41 are opened outward in the left-right direction in the single state. A line 21c in the drawing indicates an inner surface on the inside in the left-right direction of the left and right side surface portions 22c when the housing cover 40 and the front housing 20 are viewed in an overlapping manner. In FIG. 3A, the outer surfaces of the left and right facing sides 41 on the outer side in the left-right direction are inclined so as to be located on the outer side in the left-right direction toward the lower side of the outer surfaces of the left and right facing sides 41 with respect to the inner surfaces of the left and right side surface portions 22c on the inner side in the left-right direction parallel to the outer surfaces of the left and right facing sides 41 in the up-down direction.

A line T1 in the drawing indicates the lower surface of the upper surface portion 22a of the front housing 20. In FIG. 3A, the upper edge of the connecting side 47 (corresponding to the upper end of the housing cover 40) is slightly curved so as to protrude downward with respect to a straight line T1 parallel to the left-right direction (the connecting side 47 at this time is indicated by a chain line in FIG. 3C).

FIG. 3B is a front view of a state in which the housing cover 40 is attached to the opening 29 of the front housing 20 as viewed from the X direction.

As illustrated in FIG. 3B, the housing cover 40 is fitted into and attached to the opening 29 of the front housing 20 in a state of being elastically deformed so as to bring the lower ends 41c of the pair of facing sides 41 close to each other in the Y direction. The housing cover 40 fitted into the opening 29 of the front housing 20 presses the pair of facing sides 41 against the inner surface of the opening 29 (the inner surface of the outer wall portion 27) by a force to restore the state before the elastic deformation (a force of the lower ends 41c of the pair of facing sides 41 to open away from each other). With this constitution, backlash of the housing cover 40 is suppressed, and a stable attachment state is secured.

The deformation of bringing the lower ends 41c of the pair of facing sides 41 close to each other is performed by bending of the connecting side 47 which is more likely to be bent than the pair of facing sides 41. The connecting side 47 has a curved shape protruding downward in the single state, but is deformed so as to bulge upward due to deformation in which the pair of facing sides 41 approach each other. In FIGS. 3B and 3C, for example, the connecting side 47 is deformed such that the upper edge becomes parallel to the straight line T1 (overlaps the straight line T1). The connecting side 47 after the elastic deformation (indicated by a solid line in the drawing) is displaced upward by a dimension D1 with respect to the connecting side 47 before the elastic deformation (indicated by a chain line in the drawing).

By using the deformation of the connecting side 47, for example, with the constitution in which the connecting side 47 is fitted into the opening 29, the connecting side 47 can be pressed against the inner surface of the upper end of the opening 29, and the attachment state of the housing cover 40 can be further stabilized.

### 4. Action and Effect

The housing cover 40 according to one embodiment is the housing cover 40 that is attached to the opening 29 that opens toward one side in a first direction (front side in the front-rear direction) in the front housing 20 of the charging inlet 1. The housing cover 40 includes: the pair of facing sides 41 facing each other in a second direction (left-right direction) intersecting the first direction; and the connecting side 47 connecting ends (upper ends 41b) on one side in a third direction (up-down direction) intersecting the first direction and the second direction of the pair of facing sides 41. The connecting side 47 is more likely to be bent than each of the pair of facing sides 41, and in a state of being elastically deformed so as to bulge upward by displacement of bringing ends (lower ends 41c) on another side in the third direction of the pair of facing sides 41 close to each other, the housing cover 40 is fitted into and attached to the opening 29 of the front housing 20.

According to this constitution, in the bent state in which the pair of facing sides 41 is displaced so as to be close to each other, the housing cover 40 is fitted into the opening 29 of the front housing 20, whereby the pair of facing sides 41 is pressed against the inner surface of the opening 29 by a force of the housing cover 40 to restore the state before the elastic deformation (a force of the pair of facing sides 41 to open away from each other). With this constitution, the attachment state of the housing cover 40 can be stabilized after the mounting of the housing cover 40 while allowing the size of the opening 29 to have a margin for mounting the housing cover.

In addition, when the pair of facing sides 41 is displaced so as to be close to each other, the connecting side 47 that is more likely to be bent than each of the pair of facing sides 41 is curved so as to bulge toward one side in the third direction (upper side, outside of the region sandwiched between the pair of facing sides 41). In the embodiment, the connecting side 47 whose upper surface has a recessed shape before elastic deformation is curved so as to be flat or protruding after elastic deformation. According to this constitution, with the constitution in which the connecting side 47 is fitted into the opening 29, the housing cover 40 can be pressed against the inner surface of the opening 29 at three points including the connecting side 47 and the pair of facing sides 41. With this constitution, the attachment state of the housing cover 40 can be further stabilized.

In the housing cover 40, each of the pair of facing sides 41 has a hollow or bowl-like cross-sectional shape and extends in the up-down direction, and the connecting side 47 has a solid cross-sectional shape narrower than each of the facing sides 41 and extends in the left-right direction.

According to this constitution, each of the facing sides 41 has a hollow or bowl-like cross-sectional shape, whereby an increase in weight can be suppressed while securing rigidity of each of the facing sides 41. Since the connecting side 47 has a cross-sectional shape narrower than each of the facing sides 41, the connecting side 47 which is more likely to be bent than each of the facing sides 41 can be formed compactly and easily. By forming the connecting side 47 into a solid cross-sectional shape, it is possible to suppress buckling of the connecting side 47 which is likely to be bent.

The charging inlet 1 of the embodiment is the charging inlet 1 including the front housing 20 that holds a terminal, and the housing cover 40 that is attached to the opening 29 that opens toward one side in the first direction in the front housing 20.

With this constitution, by the action and effect of the housing cover 40, the attachment state of the housing cover 40 can be stabilized after the mounting of the housing cover 40 while allowing the size of the opening 29 of the housing to have a margin for mounting the housing cover 40.

Note that the constitution in the above embodiment is an example of the present invention, and various modifications can be made without departing from the gist of the present invention, such as replacing the components of the embodiment with known components.

### REFERENCE SIGNS LIST

1 Charging inlet
20 Front housing (housing)
29 Opening
40 Housing cover
41 Facing side
47 Connecting side
41b Upper end (end on one side in third direction)
41c Lower end (end on other side in third direction)

What is claimed is:

1. A housing cover that is attached to an opening that opens toward one side in a first direction in a housing of a charging inlet, the housing cover comprising:
a pair of facing sides facing each other in a second direction intersecting the first direction; and
a connecting side connecting ends on one side in a third direction intersecting the first direction and the second direction of the pair of facing sides,
wherein the connecting side is more likely to be bent than each of the pair of facing sides, and
in a state of being elastically deformed by displacement of bringing ends on another side in the third direction of the pair of facing sides close to each other, the housing cover is fitted into and attached to the opening of the housing.

2. The housing cover according to claim 1, wherein
the housing cover is fitted into and attached to the opening of the housing in a state where the connecting side is elastically deformed so as to be displaced to one side in the third direction by displacement of bringing the ends on the another side in the third direction of the pair of facing sides close to each other.

3. The housing cover according to claim 1, wherein
each of the pair of facing sides has a hollow or bowl-like cross-sectional shape and extends in the third direction, and
the connecting side has a cross-sectional shape narrower than each of the pair of facing sides and extends in the second direction.

4. The housing cover according to claim 3, wherein
the connecting side has a solid cross-sectional shape and extends in the second direction.

5. A charging inlet comprising:
a housing that holds a terminal; and
a housing cover that is attached to an opening that opens toward one side in a first direction in the housing,
wherein the housing cover includes:
a pair of facing sides facing each other in a second direction intersecting the first direction; and
a connecting side connecting ends on one side in a third direction intersecting the first direction and the second direction of the pair of facing sides,
the connecting side is more likely to be bent than each of the pair of facing sides, and
in a state of being elastically deformed by displacement of bringing ends on another side in the third direction of the pair of facing sides close to each other, the housing cover is fitted into and attached to the opening of the housing.
